(19) United States
(12) Patent Application Publication
(10) Pub. No.: US 2007/0059442 A1
(43) Pub. Date: Mar. 15, 2007

(54) Method & System for Color Matching

(76) Inventor: Anton Sabeta, Toronto (CA)

Correspondence Address: SABETA IP, 283 DANFORTH AVE, SUITE 184, TORONTO, ON, M4K-1N2, CA

(21) Appl. No.: 11/462,719

(22) Filed: Aug. 7, 2006

Related U.S. Application Data
(60) Provisional application No. 60/708,340, filed on Aug. 16, 2005.

(51) Int. Cl. B05C 13/00; B05C 11/00

(52) U.S. Cl. 427/142; 118/663

(57) ABSTRACT

A method and system for determining the color characteristics of a paint sample. The paint sample having at least one data carrier having data related to the color characteristics; an interrogator operable in a magnetic and/or electrical mode to emit interrogation signals to the data carrier, the data carrier being operable to emit the data in response to the interrogation signals.

### CROSS-REFERENCE TO RELATED APPLICATIONS

This application claims the benefit of priority to U.S. Provisional Application Ser. No. 60/708,340, filed 16 Aug. 2005.

### BACKGROUND OF THE INVENTION

1. Field of the Invention

The present invention relates to a method and system for matching color, more particularly it relates to a method of determining colour data characteristics using a data carrier.

2. Description of the Prior Art

The determination of paint characteristics is employed in industries or applications where new paint is required to be matched to an existing coat. For example, paint off an object, such as wall surface or vehicle, may require to determined or matched.

This process is often accomplished via paint analysis methods such as computerized color matching system employing spectrophotometers. Spectrotechnology measures reflected or transmitted light at many points on the visual spectrum, which results in a curve. Since the curve of each color is unique, the curve is used for identifying, specifying and matching color.

Scales for measuring colour include the Munsell System, a widely accepted color-measurement system, from the Munsell Color Science Laboratory of New York U.S.A., which defines solid color in terms of hue, value and chroma. The CIE, or Commission Internationale de l'Eclairage is the body responsible for international recommendations for photometry and colorimetry. The CIE standardized color order systems specify the light source (or illuminants), the observer and the methodology used to derive values for describing color. The CIE Color Systems utilize three coordinates to locate a color in a color space. These color spaces include: CIE XYZ, CIE L*a*b*, and CIE L*C*h^{o}. Other methods include COLORCURVE™ from ColorCurve Systems, Inc, of Indian, U.S.A., a color-matching system similar to Munsell, but based on scientific measurement of wavelengths. However, given the variables of surface characteristics, environmental effects, lighting conditions, digital capture equipment, human error, the target color may not be the true original color. Also, these methods are expensive and complex. These methods are generally used for the matching of solid colors, that is, colors shown by only a pigment which excludes a flake brilliant pigment and whose color is not changed depending on an observing direction, such as metallic paints. It is generally considered to be very difficult to match a new metallic spray paint to the original finish, even with professional equipment. Several factors influence the color, such as, the angle of metallic flakes, the pressure of the spray equipment, the temperature, the humidity, and the distance between the spray equipment and the surface. As such, the above color matching schemes typically approximate the target color.

Auto theft and insurance fraud are problems that plague owners and auto insurers alike. One of the ways to combat these problems has been to include a vehicle identification number (VIN) with each vehicle. A VIN is a set of alphanumeric characters, which contain valuable information about the history of the vehicle. The VIN follows along with vehicle ownership changes, accident history, insurance and warranty claims, recalls, thefts, registrations of and liens against the vehicle, and includes specific information such as country of origin, automobile manufacturer, body type, vehicle line, braking system and a unique serial number, year, make and model. On vehicles, trucks and motorcycles, VINs appear as small engravings, or on stickers or plates, at several locations on the vehicle. Typical vehicle theft schemes involve VIN-switching and other fraudulent practices such as: the illicit transfer of VINs from wrecked vehicles to similar ones that have been stolen; the “cloning” of VINs (a legitimate VIN, perhaps from a vehicle in a parking lot or driveway, is used to change the legal identity of a stolen vehicle of the same make, model and color). Therefore, VINs provide little protection from vehicle theft or insurance fraud due to these inherent drawbacks.

Law enforcement officials are often able to trace the identity of a hit and run vehicle, and sometimes the driver at the time of the accident, through analysis of the physical evidence from the accident scene or through eyewitness accounts. The methods for identifying a vehicle's characteristics based on vehicle paint are well known. These methods include forensic infrared spectroscopy or microscopy. Such paint analysis may be enhanced by the International Forensic Automotive Paint Data Query (PDQ) database; a searchable database of chemical and color information of original automotive paints. Often times, tips from witnesses and more conclusive lab results are needed to help solve these types of cases. For example, a local Crimestoppers Unit recently issued the following public service announcement: “Police are currently looking for a Ford F-150 or Ford Bronco manufactured between 1981 and 1986. The vehicle probably has damage on its right front end, including damage to the right front grill, headlight and turn signal area.” Another drawback of this technique is that the analysis of pigments in automotive coatings may be exhaustive, time consuming, costly and prone to human error.

It is thus one of the objects of this invention to mitigate or obviate at least one of the aforementioned disadvantages.

### SUMMARY OF THE INVENTION

In one of its aspects the present invention provides a system for matching color, the system including: at least one data carrier having data associated with the color characteristics; the at least one data carrier having a first device operable in a magnetic and/or electrical mode to emit the data in response to an interrogation signal applied by an external means.

In another aspect of the invention the present invention provides a system for determining the color characteristics associated with an object, the system having:
a portion of the object having a coat of paint having at least one data carrier associated therewith, the data carrier including a computer readable medium having data related to the color characteristics;
an interrogator operable in a magnetic and/or electrical mode to emit interrogation signals to the data carrier, the data carrier being operable to emit the data in response to the interrogation signals;
a data repository coupled to the interrogator having at least one record having information related to the color characteristics;
whereby the data emitted by the data carrier is referenced with the at least one record to provide the information about the color characteristics.

In another aspect of the invention the present invention provides a method for determining the color characteristics associated with an object, the method having the steps of: embedding at least one data carrier in the sample of paint, applying the sample of paint on the object; including data associated with the object/and or paint in the data carrier; providing an external interrogation signal to the at least one data carrier having a first device operable in a magnetic and/or electrical mode to emit data in response to the external interrogation signal.

In another aspect of the invention the present invention provides a system for determining the characteristics of a vehicle, the system having:
at least one data carrier on a portion of the vehicle's body, each data carrier being associated with data related to the vehicle and/or the portion of the vehicle body,
the data carrier having a first device operable in a magnetic and/or electrical mode to emit the data in response to activation by an activating signal applied by an external means;
   the external means having receiving means for receiving the emitted data, and logic means for processing the received data to determine the characteristics.

### BRIEF DESCRIPTION OF THE DRAWINGS

These and other features of the preferred embodiments of the invention will become more apparent in the following detailed description in which reference is made to the appended drawings wherein:

FIG. 1 is a schematic of a system for identifying an object in a preferred embodiment; and

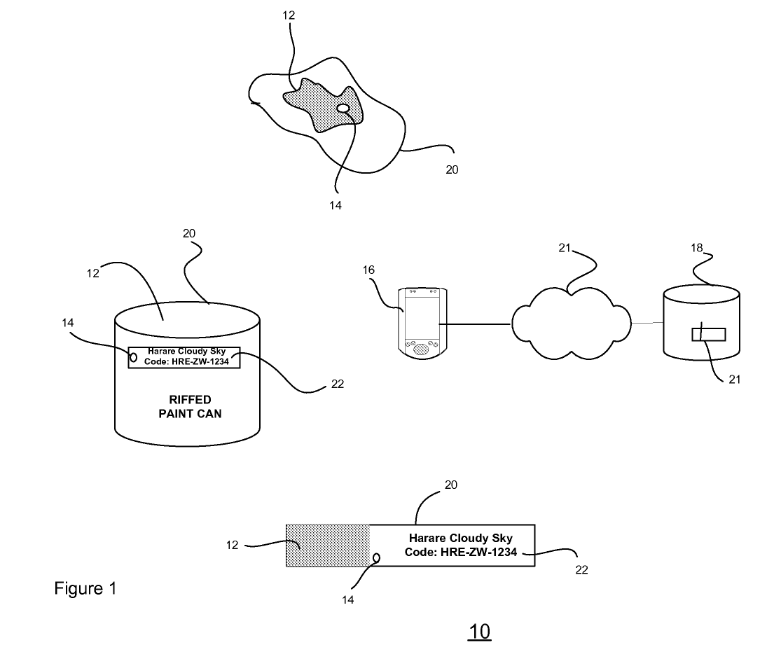

FIG. 2 is a flowchart outlining the steps for identifying an object.

### DESCRIPTION OF THE PREFERRED EMBODIMENTS

There is shown a system 10 for determining the color characteristics of a paint sample. The system includes a paint sample 12 having at least one data carrier 14 associated therewith, the data carrier 14 including a computer readable medium having data related to the color characteristics; an interrogator operable in a magnetic and/or electrical mode to emit interrogation signals to the data carrier 14, the data carrier 14 being operable to emit the data in response to the interrogation signals. Alternatively, the data may include a reference data, such as a unique identifier, which can be referenced to a data repository 18 coupled to the interrogator 16, the data repository 18 having at least one record associated with the reference data and bearing information related to the color characteristics.

A plurality of data carriers 14 are embedded within a material 12, such as paint, resin, fabric, plastic, adhesive, varnish, plastics, inks, security inks, or any other composite material or fluid material, and the material 12 is applied to an object 20 or substrate 20. The data carrier 14 is associated to the object by at least one of the group of inserting, implanting, tissue glueing, epoxy glueing, glueing, laminating, sewing, hot pressing, shrink wrapping, vacuum wrapping, soldering, encasing in plastic, rolling into, molding, strapping, stamping, retrofitting, embossing, hooking, attaching by VELCRO™, attaching by TEFLON™, meshing, emulsifying, suspending, floating or mixing in liquids, gases, slurries, swaging, electrostatic bonding, embedding by polymer polymerization. Thus, the data or unique identifier may also be related to the characteristics of the material 16, such as color characteristics, composition, or the characteristics of the associated object. The interrogator 16 queries the data carriers 14 to yield the unique identifier or data, the interrogator 16 is in communication with the database 18 bearing data related to the unique identifiers, via a network 21. The interrogator 16 may also write data to the data carriers 14.

In the preferred embodiment, the data carrier 14 is a RFID tag which operates within the RF portion of the electromagnetic frequency spectrum, such as 125 kHz, 13.56 MHz or 2.45 GHz, and uses any number of communication protocols. More specifically, the RFID tag 14 includes a processor module, a computer readable medium, a transmitter/receiver module, and antenna module. The transmitter/receiver module controls the communication of data to and from the external interrogator 16 via the antenna module. The computer readable medium serves many functions including operating protocols and data storage, and may include read-only memory (ROM), random access memory (RAM), and non-volatile programmable memory for data storage. The tag 14 data may be configured in XML, ASCII or any other format. For instance, the tag 14 may include the contactless IC chip, which is manufactured by Hitachi, Japan, measuring 0.15×0.15 millimeter (mm), 7.5 micrometer (μm) thick or the μ-chip™ which features an internal antenna. These chips can thus operate entirely on their own, making it possible to use μ-Chip as RFID IC tags without the need to attach external devices, such as antennae, making these tags, or similar tags, ideal for application in the present invention. Similar to the 0.15 mm square chip, the μ-chip is manufactured by Hitachi, Japan, using silicon-on-insulator (SOI) fabrication process technology. The μ-chip operates at a frequency of 2.45 GHz, and includes ROM for storing a unique ID and may include a non-volatile memory. Other next-generation multi-band UHF-RFID tags with built-in antenna, such as UHF-RFID chips in 800 MHz-2.45 GHz frequency-range may be used, or any tags based on the EPCglobal standard, such as the EPCglobal UHF Generation 2 standard.

The interrogator 16 includes a processor module, a computer readable medium, a transmitter/receiver module, an antenna and a power supply unit. The antenna module is coupled to the transmitter/receiver module to emit electromagnetic waves that are used to provide an interrogating field to the RFID tag 14. The interrogator 16 also includes an actuation means for powering on same.

The interrogator 16 includes an output such as a display or LED(s) for relaying information related to the tag 14 data, or a speaker for outputting auditory signals. The memory capacity on the memory module of the interrogator 16 can be unlimited, and can be coupled to other memory modules on the devices e.g. USB-flash memory, hard disk drive, floppy, optical disks (DVDs, CDs etc. The RFID tag 14 may further include interface circuitry to direct and accommodate the interrogation field energy for powering purposes and triggering of the RFID tag 14 responses. Alternatively, the interrogator 16 may be integrated in a computing device, or coupled the computing device as a peripheral. Typically, a computing device includes a processing unit, a computer readable medium including ROM, flash memory, non-volatile RAM, a magnetic disk, an optical disk, an IC memory card or a magnetic tape, input/output means. Also, the computing devices execute an operating system on the computer-readable medium such as Microsoft® Windows 9x, Me, XP, Windows CE, UNIX®, LINUX®, Pocket® PC OS or Palm OS®. Also included in the computer-readable medium is a set of instructions for performing the functions related to the system 10 or the operation of the computing device. For example, the system 10 provides a computer program product encoded in a computer-readable medium including a plurality of computer executable steps for a computing device to determine the identity of a vehicle 20. The computing devices are, but not limited to, personal computers, handheld devices, mobile computing devices, personal digital assistants (PDAs), mobile phones, pagers and microprocessor-based wireless information devices. In this case, the input/output means for interacting with the system 10 are embodied within the computing device, such as the graphical user interface, an LCD display, a touch screen display, buttons, a microphone, and a speaker. As such, the interrogator 16 may include the database 18 which may be standalone or coupled to other remote databases 18.

The interrogator 16 transmits activating signals or interrogation signals to the tag 14 upon actuation. The interrogator 16 may include a network interface for coupling to a computing device or network 21. The interrogator 16 may be coupled via a wired or wireless connection, such as Ethernet, IEEE 1394, TDMA, CDMA, GSM, PTSN, ATM, ISDN, 802.1X, USB, Parallel, Serial, UART (RS-232C). In this case, the input/output means for interacting with the system 10 are embodied within the computing device, such as the graphical user interface, LCD display, buttons, touch screen display, microphone, and speaker.

The color matching system can thus be used in retail paint sales and home decor services. Great flexibility and can be achieved with networkable installation, portable measurement instruments, available paint databases (plus the ability to create new databases). The system 10 can accurately determine the color of products, or the characteristics of the objects 20, such as extruded vinyl, bulk goods such as adhesives, roofing materials, coatings, sealants, coil coatings, resins, synthetic films, paints (wet and dry), textiles, carpeting, granules, food pigments, paper, powders, glass, ceramics, paper, metal, minerals, paper, and plaster. Other uses are corporate logo standardization, color testing of inks, color control of paints, control of printed colors on packaging material and labels, color control of plastics and textiles throughout the development and manufacturing process, finished products like printed cans, clothing, shoes, automobile components, plastic components of all types, films, shrink sleeves for holograms, printed labels, identification documents such as passports, identification cards, official documents, consumer packaging, and so forth. Generally, any product that allows for association with a data carrier can be used with the present invention to determine associated color, or identity of the product. As an example, such methods of association include, but are not limited to, inserting, implanting, tissue glueing, epoxy glueing, glueing, laminating, sewing, hot pressing, shrink wrapping, vacuum wrapping, soldering, encasing in plastic, rolling into, molding, strapping, stamping, retrofitting, embossing, hooking, attaching by VELCRO™, attaching by TEFLON™, meshing, emulsifying, suspending, floating or mixing in liquids, gases, slurries, swaging, electrostatic bonding, embedding by polymer polymerization. More so, the data carrier 14 can be incorporated in the products for both identity and authentication, and can thus assist in the fight against counterfeiting such as paper pulp, woven fibers, printer inks and varnish, copier and digital printer toner, plastics, paints, stains, glass, fertilizers and explosives.

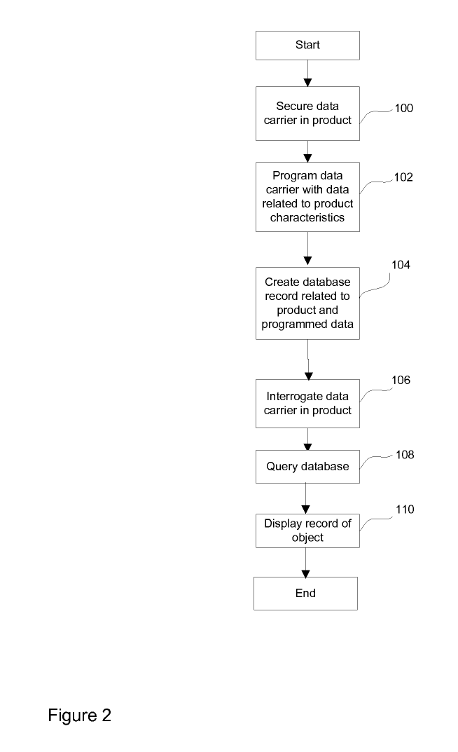

In another example, the determination of the paint details in industries or applications where new paint is required to be matched to an existing coat, or previous coat, can also be performed with the steps outlined in the flowchart of FIG. 2. Although commercial paints 20 often include a sticker 22 or swatch 20 with the paint details 22, such as chroma composition, hue or value, should the sticker or swatch be missing, eligible, painted over, paint analysis has to be performed in an attempt to determine the paint details. The tags 14 in the paint coat on a target surface or paint chip thus include paint details that can be readily determined by an interrogator 16. The data includes, among others, color characteristic data, micro-brilliance-feeling data corresponding to the paint blends and/or full-color paints.

The color code number designated for each painted product maker and a paint blend for refinish paint in accordance with the color number is entered in the computer. The paint blend can thus include certain percentages of different components or colourants. For example, a full-color paint species (Part by weight) may include the following components: Silver A (Metallic full color A) 64.38 Silver B (Metallic full color B) 6.50 Blue A (Blue full color A) 0.32 Black A (Black full color A) 0.26 Auxiliary agent A (Aluminum-oriented 18.79 adjuster A) Auxiliary agent B (Aluminum-oriented 9.75 adjuster B). Therefore the tag data includes the blending ratio of the colorants, the luster color materials, and other additives, in metallic or pearlescent paint.

Alternatively, the paint swatches, commonly used by designers or paint vendors, may include tags 14 that are read by an interrogator 16 and a truer representation of the swatch color is outputted on a display. Generally, the variables of paper, humidity, lighting conditions, inks, time, human error, press speeds, the color on the paint swatch may not be the true intended color. By having the swatch colors stored in a computer readable medium, the swatches can be viewed at a later time, for example, a user can receive interrogate the tags 14 on the swatches to read the unique identifier related to a color stored on a database 18, and the associated color is displayed and stored in a computer readable medium for future reference. Advantageously, the color may be displayed in a setting or environment for which the paint is being contemplated for, such as a living room, bathroom or office. Alternatively, unique identifiers and the associated paint colors may be downloaded onto a suitably equipped computing device for storage and viewing, thus bypassing the scanning step, and the desired paint may be ordered via the suitably equipped computing device coupled to the network 19. The tag 14 may further include information relating to the paint manufacturer, date of manufacture/preparation, point of sale, URI for further information or design/application tips, suitable surfaces or objects 20 for painting, durability.

Manufacturers of bulk materials (adhesives, roofing materials, coatings, sealants, etc.), commonly encounter counterfeiting, product substitution and product liability issues. The most common product liability concern arises when building contractors substitute less expensive, lower quality products for the original product. This may result in product failure, and a potential customer warranty claim.

In operation, the identity of an object 20 is determined by a method outlined in the flowchart of FIG. 2, as an example. The method includes the steps of embedding at least one data carrier 14 in a material 12, and using any of the afore-mentioned methods of association to secure to the object 20, the data carrier 14 having a device operable in a magnetic and/or electrical mode to emit data in response to an activation signal from an interrogator 16 (step 100). In step 102, the data carrier 14 is associated with data related to the object 20. The data may include a unique identifier which is associated with comprehensive data on the object 20. The unique identifier is linked to a data record is stored in a database (step 104). In step 106, the data carrier 14 is interrogated to acquire the associated data, such as the unique identifier, and the database 18 is queried for the data record associated with the unique identifier (step 108); and the information in the data record is outputted (step 110) via an output means. It should be noted that data carrier 14 may alternatively be encoded with data associated with the object 20 or material following the application, association or securement of the data carrier 14 to the object 20 or material. In any event, these steps may be performed in any logical sequence as long as the desired objective of object 20 determination is achieved.

The system 10 is used in the identification of wide range of objects 20 or products. The method and system for determining the identity of an object 20 based on the data included in at least one data carrier 14 embedded in a coating applied to the object 20 will now be described, with particular reference to vehicles 20, as an example. Generally, the identification of vehicles 20, which may be land, subterranean, water or air based, is important to combat theft, fraud and is helpful in vehicle accident investigations or forensic analysis.

In one application of the present invention, the characteristics of a vehicle 20 can be determined from a sample 12 of paint. Advantageously, the identity of the vehicle 20 and associated owner or driver can be determined in an expeditious and less costly manner, compared to the methods of the prior art. Also, the insurance terms, conditions and coverage may be more favourable for drivers with vehicles 20 bearing data carriers 14; this would be achieved through cooperation between the insurance companies and the law enforcement officials.

For the identification of vehicles 20, the method starts in an exemplary paint shop process, where following welding, a vehicle body 20 is immersed in a cleaning bath, followed by an electro-coat dip to complete the rust proofing process. The vehicle body 20 is then associated with a carrier 14 known as a dolly which has programmable means having the subsequent paint process variables. Once the under body coating has been applied, the vehicle body 20 enters a baking oven at a specified temperature and duration, followed by application of a primer paint coat, and once again the vehicle body 20 is introduced into another oven at specified temperature and duration. Finally, the topcoat spray is applied to the vehicle body 20, and the body 20 is introduced into the final paint oven. Typically, the tags 14 may be included in the electro-coat dip or any of the other paint coats, and thus include the ability to withstand the heat of an automotive paint curing ovens. The tags 14 may be encoded with the relevant vehicle 20 data before the start of the painting process, during the painting process or after the painting process. As such different portions of the vehicle 20 may include tags 14 having data related to their location on the vehicle 20—for example, a tag 14 on the passenger door would include data indicating that the tag is associated with the passenger door, which may further include its location on the passenger door area. Such information would be helpful in hit and run investigations.

In the process for vehicle identification, each vehicle 20 is associated with a unique identifier. The unique identifier may be included in any suitable means for retaining data operable in an electrical or magnetic mode, such as a radio identification (RFID) tag 14, as implemented in the preferred embodiment. A government-regulating agency, such as the Department of Motor Vehicles, or other authorised parties, issues the unique identifiers or the tags 14 having the unique identifiers. The unique identifier may include a serial number or alphanumeric characters related to the vehicle 20.

As an example, automotive paint bearing tags 14 is made available only from authorized parties or government agencies, and may be restricted to certain geographic zones. The amount of paint required for a vehicle 20 depends on the size of the vehicle 20, and the type of paint used. As such, there are a sufficient number of tags 14 per volume of paint (ppm) such that any particular surface area of the vehicle 20 would have at least one tag 14 that may be harvested from a sample 12 of paint recovered from a vehicle 20, or on the vehicle 20 to successfully determine the data contained therein. Often times hit and run accidents involve structures other than other vehicles 20 or persons, such as structures commonly found on the carriageway, such as, a road sign, traffic signal, lamp post, telegraph pole, electricity pole, tree, bus stop, bus shelter, central crash barrier, nearside or offside crash barrier, building, fence, bridge, or other permanent object. Marine accidents may include exemplary structures such as pier, buoy, and other marine vehicles 20. Paint chips or smear bearing the tags 14 may be harvested from any of these structures. Using information yielded from the tags 14 from any of these structures can yield the identity of the vehicle 20 and often the hit and run driver, and the victims may file charges to get compensation for the property damage, or file other claims.

The tags 14 are read or accept interrogation requests from authorized interrogators 16 and/or authorized parties, such as law enforcement officials or issuing authorities; and can be written only by authorized interrogators 16 and/or authorized parties, such as law enforcement officials or issuing authorities. The data related to the identifiers is maintained in a computer readable medium, such as a database 18 or a plurality of databases 20 which may be coupled to one another. The unique identifier may be a pointer to a database record related to the unique identifier and hence the object 20 or material 16.

The system 10 supports various security features that ensure the integrity, confidentiality and privacy of information stored or transmitted, such as mutual authentication, where the tag 14 can verify whether the interrogator 16 is authentic and can prove its own authenticity to the interrogator 16 before starting a secure transaction. Another feature is information security to maintain data protection for information stored on tag 14 via encryption of the data on the tag 14, and encryption for communication between the tag 14 and the interrogator 16 to prevent eavesdropping. Other security technologies may also be used to ensure information integrity. Additionally, the tag 14 may include built-in tamper-resistance by employing a variety of hardware and software capabilities that detect and react to tampering attempts and help counter possible attacks. The system 10 may also include the ability to process information and uniquely provide authenticated information access and protect the privacy of personal information. The tag 14 can verify the authority of the information requestor 20 and then allow access only to the information required. Access to stored information can also be further protected by a challenge-response scheme, such as a personal identification number (PIN) or biometric to protect privacy and counter unauthorized access.

Therefore, in cases of vehicle theft, insurance investigations, auctions or used-car dealings, the vehicle 20 is scanned thoroughly to interrogate any tags 14 that may be present in any of the paint coats, such as the under-body paint coat, rust proofing coat, primer, topcoat or final coat. Therefore, even in the event that a perpetrator attempts to strip the vehicle 20 of the existing paint coats, and/ or paint over the vehicle 20, there is substantially high probability that at least one of the tags 14 will be present. To that end, the tags 14 may also be applied to non-obvious locations or concealed and hard-to-reach locations on the vehicle 20, such as body panel, body frame, chassis, trim parts, or engine parts. As such the tags 14 may be included in any fluid, resin or substrate that can retain the tags 14 and applied to the vehicle 20 or parts of the vehicle 20, such as paint or adhesive. Also, the tag 14 may be invisible to the naked eye or may be included in a clear fluid, resin or substrate, such as paint, rustproof paint or adhesive, so as to substantially preclude removal by a perpetrator. In the case of vehicle identification as a part forensic examination, a recovered paint chip or smear including the RFID tag 14 with a unique identifier is linked to a data record bearing the VIN number, which would lead to the current owner of the vehicle 20 or the driver of the vehicle 20.

Generally, the database 18 may also include a VIN validation module for processing a VIN validation routine using algorithms that check the format of VINs. The validated VINs can be stored in a VIN database 18. In operation, the VIN validation module uses the algorithms and/or the VINs in the VIN database 18 to determine whether the VIN for a particular vehicle is valid and then outputs the associated data. The VIN database 18 having data records relating to vehicles 20, is maintained by, and accessible only to, the government-regulating agency or the authorised issuing parties, and other authorised parties institutions. However, even if the unique identifier becomes known to unintended or unauthorised parties then this information is useless without access to the database record.

In yet another embodiment, the data carrier 14, such as an RFID sensor tag 14, which is positioned on portions of the vehicle 20, such as front, back, offside, nearside, roof or underside. The tag 14 is associated with data related to the vehicle data and/or the portion of the vehicle body 12. This data point of contact is an accident may also be useful in accident investigations.

In another embodiment, the RFID tag 14 is active. Thus, the active tag 14 incorporates an additional energy source, such as a battery, into the tag 14 construction. This energy source permits active RFID tag 14 to create and transmit relatively strong response signals even in regions where the interrogating radio frequency field is relatively weak, and thus an active RFID tag 14 can be detected at greater range. Those skilled in the art, however, will recognize that active and/or passive tags 14 share many features and that both can be used with this invention. Alternatively, the RFID tag 14 is semi-active, in that it uses an additional energy source, such as a battery, and the energy derived from the external means, such as an interrogator 16.

In yet another embodiment, the data carrier 14 includes chipless tag and thus stores information purely in the electromagnetic materials which comprise the tag 14, such as magnetoelastic resonant materials (magnetostricitive alloys), harmonic magnetic materials, multi-resonant LC planar structures. Alternatively, the tag 14 may employ tagging technologies which are based purely on printed RFID materials, such as ink, without the need for any electronic chip, such that the tag 14 includes printed an RFID antenna and/or printed RFID sensor elements. Also, the data carrier 14 may include a computer readable medium, or memory chip, capable of storing information, that draws its power from an interrogator 16 through a process called inductive coupling via its built-in antenna.

In yet another embodiment, the system 10 employs Near Field Communication (NFC) technology, a very short-range radio frequency identification (RFID) protocol that provides secure communications between various devices. By having this relatively short read distance, security is enhanced as this substantially diminishes the possibility of eavesdropping or man-in-the middle attacks.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A system for matching color, the system including:
at least one data carrier having data associated with said color characteristics; said at least one data carrier having a first device operable in a magnetic and/or electrical mode to emit said data in response to an interrogation signal applied by an external means.

2. The system of claim 1, wherein said at least one data carrier is included with a product bearing said color.

3. The system of claim 2, wherein said product is any of the following: adhesives, roofing materials, coatings, sealants, coil coatings, resins, synthetic films, paints textiles, carpeting, granules, food pigments, paper, powders, glass ceramics, inks, paper, metal, minerals, paper, and plaster.

4. The system of claim 1, wherein said external means includes a second device for emitting said activating signal in an electric and/or magnetic mode, said second device including a transmitter and/or receiver, wherein said second device is included with any of the following: a mobile device, a handheld device, a computing device, a standalone transceiver, a standalone transceiver coupled to a network, a standalone transceiver coupled to a computer.

5. The system of claim 1, wherein said color characteristics include chroma composition, hue or value, texture, additives.

6. A system for determining the color characteristics associated with an object, the system having:
a portion of the object having a coat of paint having at least one data carrier associated therewith, the data carrier including a computer readable medium having data related to the color characteristics;
an interrogator operable in a magnetic and/or electrical mode to emit interrogation signals to the data carrier, the data carrier being operable to emit the data in response to the interrogation signals;
a data repository coupled to the interrogator having at least one record having information related to the color characteristics;
whereby the data emitted by the data carrier is referenced with the at least one record to provide the information about the color characteristics.

7. The system of claim 6 wherein said at least one data carrier is associated to said object by at least one of the group of inserting, implanting, tissue glueing, epoxy glueing, glueing, laminating, sewing, hot pressing, shrink wrapping, vacuum wrapping, soldering, encasing in plastic, rolling into, molding, strapping, stamping, retrofitting, embossing, hooking, attaching by VELCRO™, attaching by TEFLON™, meshing, emulsifying, suspending, floating or mixing in liquids, gases, slurries, swaging, electrostatic bonding, embedding by polymer polymerization.

8. A method for identifying an object based on analysis of a sample of paint from said object, the method having the steps of:
embedding at least one data carrier in said sample of paint, said data carrier having data associated with said object, said data including a unique identifier related to said object;
said at least one data carrier having a comprising a first device operable in a magnetic and/or electrical mode to emit data in response to an interrogation signal applied by an external means.

9. The method of claim 8, wherein the object is a vehicle and the method includes the further steps of determining the characteristics of a vehicle from a paint sample, the method having steps of:
coding an data carrier with a unique identifier,
embedding the data carrier in the paint substrate;
applying the paint on a vehicle,
associating a record of information relating to the vehicle and an owner of the vehicle with the unique identifier,
querying the data carrier with an interrogator to obtain the unique identifier, using the unique identifier to obtain the record, and responding to the query with information in the record.

10. The method of claim 8 including a step of encoding the data carrier with location specific data in relation to the data carrier's location on the vehicle.

11. The method of claim 8, wherein said data includes any of the following: unique identifier, VIN, make, color, owner, driver, manufacturer, date of manufacture, dealer details, or historical vehicle data.
